(19) United States
(12) Patent Application Publication
(10) Pub. No.: US 2006/0277183 A1
(43) Pub. Date: Dec. 7, 2006

(54) System and method for neutralizing locked pestware files

(76) Inventors: Tony Nichols, Erie, CO (US); Michael Burtscher, Longmont, CO (US)

Correspondence Address: COOLEY GODWARD KRONISH LLP;ATTN: PATENT GROUP, THE BOWEN BUILDING, 875 15TH STREET, N.W. SUITE 800, WASHINGTON, DC, 20005-2221, US

(21) Appl. No.: 11/145,593

(22) Filed: Jun. 6, 2005

(51) Int. Cl. G06F 17/30

(52) U.S. Cl. 707/9

(57) ABSTRACT

Systems and methods for scanning and deleting pestware on a protected computer are described. In one variation, the presence of a pestware file on the storage device is detected while an operating system of the protected computer is limiting access to the pestware file via the operating system. In order mitigate any undesirable consequences the pestware might cause, a listing of a plurality of pointers to data for the pestware file is altered while the operating system continues to limit access to the file via the operating system. In this way, the operating system will be unable to locate and launch the pestware file. In variations, the name of the pestware file from a directory entry of the pestware file. In systems where the files are organized in an NTFS format, an MFT bitmap may be removed as well.

### RELATED APPLICATIONS

The present application is related to the following commonly owned and assigned applications: application Ser. No. 10/956,578, Attorney Docket No. WEBR-002/00US, entitled System and Method for Monitoring Network Communications for Pestware; application Ser. No. 10/956,573, Attorney Docket No. WEBR-003/00US, entitled System and Method For Heuristic Analysis to Identify Pestware; application Ser. No. 10/956,574, Attorney Docket No. WEBR-005/00US, entitled System and Method for Pestware Detection and Removal; application Ser. No. 11/104,202, Attorney Docket No. WEBR-011/00US, entitled System and Method for Directly Accessing Data From a Data Storage Medium; application Ser. No. (unassigned), Attorney Docket No. WEBR-024/00US, entitled System and Method for Analyzing Locked Files, filed on Jun. 6, 2005, each of which is incorporated by reference in their entirety.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to computer system management. In particular, but not by way of limitation, the present invention relates to systems and methods for controlling pestware or malware.

### BACKGROUND OF THE INVENTION

Personal computers and business computers are continually attacked by trojans, spyware, and adware, collectively referred to as “malware” or “pestware.” These types of programs generally act to gather information about a person or organization—often without the person or organization's knowledge. Some pestware is highly malicious. Other pestware is non-malicious but may cause issues with privacy or system performance. And yet other pestware is actual beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

Software is available to detect and remove pestware, but removing pestware from a system is frequently problematic because the system's operating system typically locks a pestware file when a pestware process associated with the pestware file is running in the system's memory. As a consequence, the operating system prevents existing pestware removal software from analyzing the locked file and/or deleting the pestware file.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Embodiments of the present invention include systems and methods for removing pestware files from a protected computer. In one embodiment, the presence of a pestware file is detected on the storage device while the operating system of the protected computer is limiting access to the pestware file via the operating system. While the operating system continues to limit access to the file via the operating system, a listing of a plurality of pointers is altered. Each of these pointers in the listing points to a corresponding one of a plurality of locations on the storage device, and the storage device stores each of a plurality of portions of data for the pestware file at a corresponding one of each of the plurality of locations. In variations, while the operating system continues to limit access to the file via the operating system, the name of the pestware file is removed from a directory entry of the pestware file.

In another embodiment, the invention may be characterized as a system for managing pestware, which includes a pestware detection module configured to detect pestware on a protected computer and a file removal module configured to remove the pestware from the protected computer. The removal module in this embodiment is configured to alter, while the operating system prevents access to the pestware file via the operating system, a listing of a plurality of pointers. Each of the plurality of pointers in the listing points to a corresponding one of a plurality of locations on the file storage device, and the file storage device stores each of a plurality of portions of data for the pestware file at a corresponding one of each of the plurality of locations. In this way, the altered listing of pointers prevents the operating system from accessing the pestware file.

In yet embodiment, the invention may be characterized as a computer readable medium encoded with instructions for removing pestware files from a storage device of a protected computer, the instructions including instructions for detecting a presence of a pestware file on the storage device while the operating system of the protected computer is limiting access to the pestware file via the operating system and altering, while the operating system continues to limit access to the file via the operating system, a listing of a plurality of pointers. Each of the plurality of pointers in the listing points to a corresponding one of a plurality of locations on the storage device, and the storage device stores each of a plurality of portions of data for the pestware file at a corresponding one of each of the plurality of locations. The instructions include instructions for removing, while the operating system continues to limit access to the file via the operating system, the name of the pestware file from the directory entry of the pestware file. These and other embodiments are described in more detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 illustrates a block diagram of a protected computer in accordance with one implementation of the present invention;

FIG. 2 is a flowchart of one method for accessing information from a plurality of files in accordance with an embodiment of the present invention; and

FIG. 3 is a flowchart of a method for removing files that are locked by an operating system of the protected computer in accordance with another embodiment of the present invention.

### DETAILED DESCRIPTION

According to several embodiments, the present invention permits a file that is inaccessible via the operating system (e.g., because it is locked by the operating system) to be accessed, analyzed and removed. In other words, while a file remains inaccessible via the operating system (e.g., because the file is being executed), several embodiments of the present invention allow the locked file to be analyzed to determine if the file is a pestware file, and if it is, then to remove the ordinarily inaccessible file.

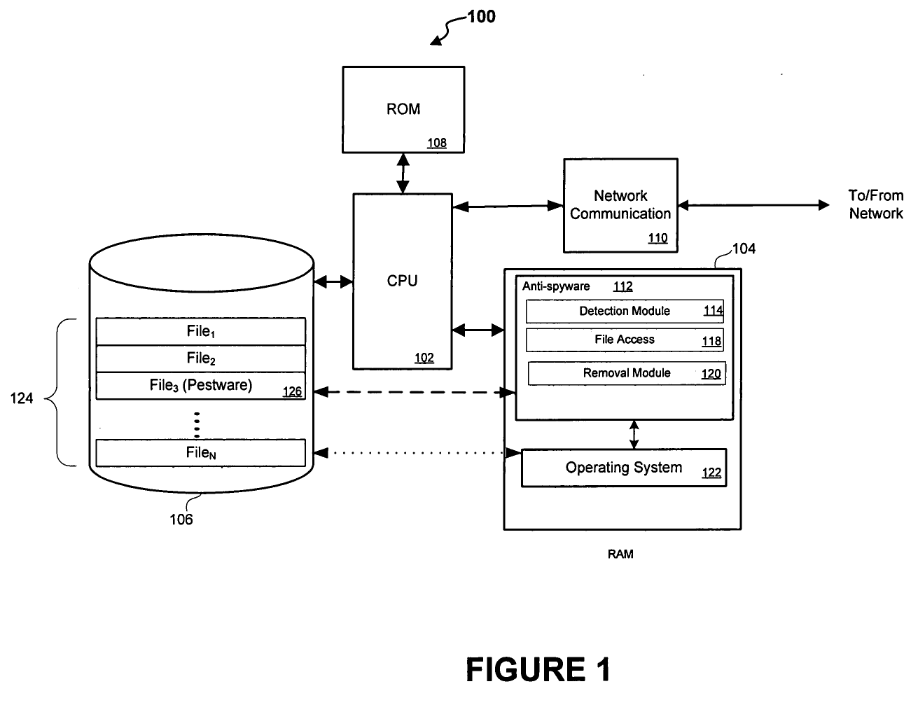

Referring first to FIG. 1, shown is a block diagram 100 of a protected computer/system in accordance with one implementation of the present invention. The term “protected computer” is used herein to refer to any type of computer system, including personal computers, handheld computers, servers, firewalls, etc. This implementation includes a CPU 102 coupled to memory 104 (e.g., random access memory (RAM)), a file storage device 106, ROM 108 and network communication 110.

As shown, the file storage device 106 provides storage for a collection of N files 124, which includes a pestware file 126. The file storage device 106 is described herein in several implementations as hard disk drive for convenience, but this is certainly not required, and one of ordinary skill in the art will recognize that other storage media may be utilized without departing from the scope of the present invention. In addition, one of ordinary skill in the art will recognize that the storage device 106, which is depicted for convenience as a single storage device, may be realized by multiple (e.g., distributed) storage devices.

As shown, an anti-spyware application 112 includes a detection module 114, a file access module 118 and a removal module 120, which are implemented in software and are executed from the memory 104 by the CPU 102. In addition, an operating system 122 is also depicted as running from memory 104.

The software 112 can be configured to operate on personal computers (e.g., handheld, notebook or desktop), servers or any device capable of processing instructions embodied in executable code. Moreover, one of ordinary skill in the art will recognize that alternative embodiments, which implement one or more components (e.g., the anti-spyware 112) in hardware, are well within the scope of the present invention.

Except as indicated herein, the operating system 122 is not limited to any particular type of operating system and may be operating systems provided by Microsoft Corp. under the trade name WINDOWS (e.g., WINDOWS 95, 98, 2000, NT and XP). Additionally, the operating system 122 may be an open source operating system such operating systems distributed under the LINUX trade name. For convenience, however, embodiments of the present invention are generally described herein with relation to WINDOWS-based systems. In light of the teaching disclosed herein, those of skill in the art can adapt these implementations for other types of operating systems or computer systems.

In accordance with several embodiments of the present invention, the file access module 118 enables data in one or more of the files 124 to be accessed notwithstanding one or more of the files 124 may be locked by the operating system 122. For example, when there is a pestware process running in memory 104 that is associated with the pestware file 126, the operating system 122 may lock the pestware file 126 so as to prevent a user of the protected computer 100 from accessing data of the file 126. As a consequence, in prior art systems, it would be very difficult to assess whether the pestware file 126 was indeed pestware. In several embodiments of the present invention, however, the files 124 are accessible so that data in one or more of the files 124 may be analyzed (e.g., by the detection module 114) so as to identify whether any of the files 124 are pestware files.

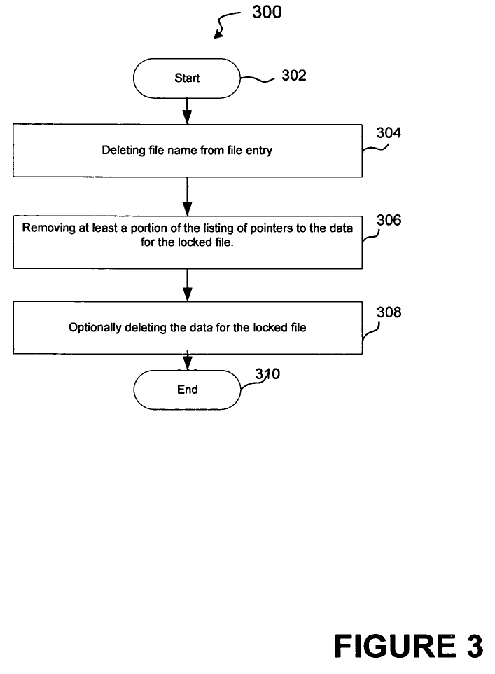

The removal module 120, as discussed further with reference to FIG. 3, enables files to be rendered inaccessible even if the operating system 122 is limiting access to the files. In operation for example, when a particular locked file is identified as pestware (e.g.; the pestware file 126) the removal module 120 renders the pestware file inaccessible by removing pointers to data for the pestware file. In addition, the name for the file may be removed from the directory entry for the pestware file. In yet other variations, to further ensure data underlying the pestware file is inaccessible, some or all of the data associated with the pestware file is removed from the file storage device 106.

It should be recognized that the file access module 118 and the removal module 120 are identified as separate modules only for ease of description and the file access module 118 and the removal module 120 in several embodiments utilize the same components (e.g., the same collection of code) for carrying out similar functions.

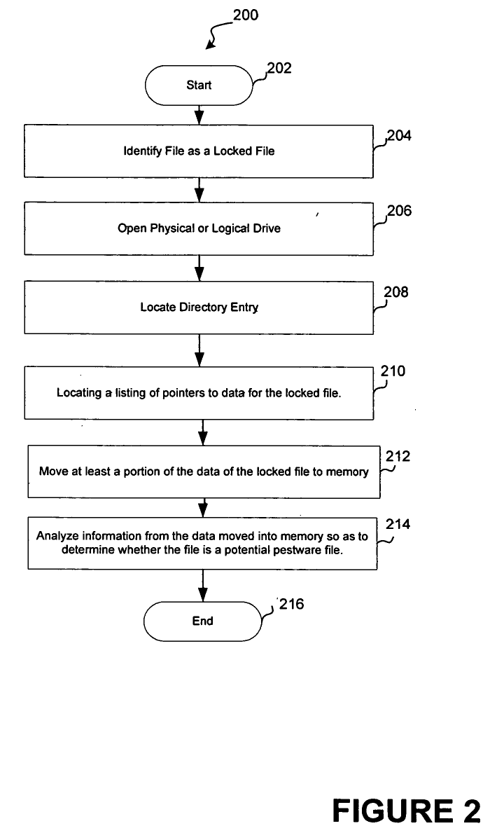

Referring next to FIG. 2, shown is a flowchart depicting steps traversed in accordance with a method for accessing data from files in the data storage device 106. In the exemplary method, a file is initially identified as a locked file (e.g., the operating system 122 limits access to the file via the operating system's file access calls) (Blocks 202, 204).

In some embodiments, before steps are carried out to access data of a locked file, the file path (e.g, a fully qualified path (FQP)) for the file is identified, but this is not required. Next, a physical or logical drive where the locked files resides is opened for reading and writing (Block 206). In some instances, it is beneficial (when possible) to lock the volume so as to prevent the operating system 122 from doing any reading or writing while the file access module 118 is accessing data from the storage device 106.

In addition, in various embodiments, the content in cache of the protected computer that is associated with the locked file is flushed to the drive. This may be carried out as a safety measure so that is the file is determined to be pestware, and the file is removed (as discussed further in reference to FIG. 3) the file is not regenerated by the operating system 122.

In several embodiments, once a file is identified as a locked file and the information about the volume where the file resides is obtained, then the directory entry for the file is located (Block 208).

In order to locate the directory entry and access data from the locked file, information about where the volume's (i.e., the partition) files reside (e.g., C drive, D drive, etc.) is obtained. If the Physical Disk Mode is utilized, then sector zero, the partition table, is read so as to obtain the starting sectors for the volumes on the drive. In several embodiments, the Boot Record, which starts at logical sector zero, is accessed to obtain the BIOS Parameter Block (BPB). The BIOS parameter block includes the following useful information for both NTFS and FAT file systems:

i. Bytes per sector

ii. Sectors per cluster

iii. Reserved sectors

iv. Media type

v. Hidden sectors

vi. Total sectors in Volume (or partition).

The following three pieces of information are available from the bios parameter block in an NTFS system:

vii. Logical cluster number for the MFT

viii. Clusters per file record segment

ix. Cluster per index block.

In a FAT system, the following three pieces of information are available from the BIOS parameter block:

x. The number of File Allocation Tables, FAT

xi. The number of root-directory entries.

xii. The number of sectors per FAT

When the storage device 106 is organized according to an NTFS file structure, in one embodiment, an iterative process of looking in subdirectories of the Fully Qualified Path is carried out until the directory entry of the locked file is located.

Specifically, in this embodiment, beginning with the root directory, each directory entry in the Directory Index is read and the master file table (MFT) record for each entry is accessed and placed into memory (e.g., memory location number one (M1)). The validity of each MFT file record is determined, and if it is not valid then the process is aborted. But, if the MFT file record of each entry is valid and the file name of the locked file is reached in the directory index, the file entry for the locked file is read from the directories index so as to obtain the MFT file record number for the locked file.

The MFT includes several pieces of information that are useful in this process of locating the directory entry of the locked file. As a consequence, in some embodiments, the MFT table is located by accessing the bios parameter block (BPB), and the first seven MFT File Record entries (0 . . . 6) are read into memory (e.g., memory location zero (M0)). The file record number 0 of the MFT includes information to locate all of the MFT File Record Locations and the MFT Bitmap Data Runs, which enable the clusters of the directory indexes to be located. File record number 6 contains the Data Bitmap Location on the drive, and file record number 5, which is the root directory entry, includes information to locate the Index Attribute for the MFT file record number 5.

To find the directory entry for the locked file in a FAT file structure, the first directory entry in the root directory is located along with the first cluster location for the first directory entry. If the first directory entry is not the locked file, then each successive directory entry (and its associated data cluster(s)) are located until the directory entry for the locked file is located.

When a directory entry occupies a single cluster, then the next directory entry is located simply by looking in that single cluster. In the event a directory entry occupies more than one cluster, however, then the FAT entries, which operate as pointers, are followed to each cluster associated with the directory entry until either an end of file (EOF) marker is located for the directory entry or the next directory entry is located.

Once the directory entry for the locked file is located (Block 208), then a listing of pointers to data for the locked file is located (Block 210). In the context of an NTFS file system, if the file's data resides within the MFT File Record itself, then a flag in the “Data Attribute” indicates whether the data for the file is resident or non-resident in the MFT file record. If the data for the locked file is resident in the MFT file record, then the actual data for the file will be within the Data Attribute itself. In addition, other attributes within the MFT are, for example, “File Name” and “File Information.”

If the data for the locked file does not reside entirely within the MFT record for the file, then the listing of pointers, according to an exemplary embodiment, includes the Data Runs in the MFT record, which point to the clusters where the data for the file is stored on the storage device 106.

When the file system is a FAT system, one pointer includes a pointer to the first FAT entry in the File Allocation Chain, which is located by reading the directory entry of the locked file. Once the first FAT entry is located, pointers to the data for the locked file include the addresses in the FAT entries of the File Allocation Chain that identify the locations of data for the locked file and link the File Allocation Chain together.

Once the location of data for the locked file is located, at least a portion of the data of the locked file is moved to memory (Block 212). The data from the locked file that is in memory is then analyzed so as to determine whether the locked file is a potential pestware file (Block 214).

In several embodiments, the detection module 114, it is responsible for detecting pestware or pestware activity on the protected computer 100 based upon the information received from the data associated with the locked file. In one embodiment for example, the detection module compares a representation of known pestware files (e.g., a cyclical redundancy check (CRC) of a portion of a known pestware file) with a representation (e.g., CRC) of a portion of the locked file. In one variation, only 500 Bytes of information are retrieved from data associated with the locked file and a CRC of the 500 Bytes of information retrieved from the file is compared with the known pestware definitions. If the 500 Bytes of retrieved information indicates the file is a potential pestware file, then a more thorough analysis (e.g., an analysis of the entire file) may be conducted. In this way, the comparison of each file with definitions of pestware files is expedited. Various techniques for detecting pestware are disclosed in the above-identified and related application entitled: System and Method for Monitoring Network Communications for Pestware.

Referring next to FIG. 3, shown is a flowchart, which depicts exemplary steps carried out when deleting a locked file in accordance with an exemplary embodiment of the present invention. As shown in FIG. 3, the name of the locked file is initially deleted from the file entry (Blocks 302, 304).

In the context of an NTFS file system, the number of file names associated with the locked file are given in the MFT File Record. In the exemplary embodiment, all of the file names (there will never be more than two or less than one file name) associated with the locked file are located and changed. If the locked file has a Short File Name (SFN) and a Long File Name (LFN) then there are two file names. In one embodiment, a copy of the Directory Index is stored in memory (e.g, memory 104) and the filename(s) are located and removed from the copy of the Directory Index. Next. the updated MFT entry is written back to the same location that it was read from before the changed copy of the Directory Index (i.e., the copy stored in memory) is written to the drive.

If the file system is a FAT file system, then each of its filenames (e.g., long file names and short file names) are deleted by adding the American Standard Code for Information Interchange (ASCII) character 0xE5. Optionally, for added security, all of the characters except for the 0xE5 character are overwritten with zeros.

As shown in FIG. 3, at least a portion of the listing of pointers to the data for the locked file are altered so as to prevent the data from being accessed and executed (Block 308). In an NTFS system, the pointers identified at Block 210 are altered by reading into memory, portions of the Data Bitmap that are associated with the locations of Data Runs identified in Block 210 (i.e, the Data Runs from entry 6 of the MFT) and zeroing each correlating-bit in the stored portion of the Data Bitmap that is associated with each cluster within the Data Runs. The altered portion of Data Bitmap is then written back to the drive. The altered Data Bitmap tells the operating system 122 that the data clusters associated with the data runs of the locked file are no longer in use, and as a consequence, the operating system will no longer be able to access the data for the locked file.

Next, in the exemplary embodiment, the MFT Bitmap is read into memory and the bit that tells the operating system 122 about the availability of the MFT Entry is zeroed out so as to indicate the MFT entry for the locked file is now available for reuse. The MFT Bitmap is then written back onto the drive.

In the context of a FAT system, the listing of pointers to the data for the locked file include the FAT entries for the locked file. In order to alter the listing of pointers, the FAT table is read into memory and these FAT entries for the locked file are zeroed out and the FAT table is rewritten back to the drive. In the event there is more than one FAT table on the drive, the entries for the locked file in each FAT table are zeroed out.

As shown in FIG. 3, the data on the storage device 106 associated with the locked file may be optionally deleted (e.g., to improve privacy). (Block 308). In an NTFS system, for example, one or more of the data clusters associated with the Data Runs may be erased, and in a FAT system one or more of the data clusters for each of the FAT entries in the FAT chain may be erased.

In conclusion, the present invention provides, among other things, a system and method for managing pestware. Those skilled in the art can readily recognize that numerous variations and substitutions may be made in the invention, its use and its configuration to achieve substantially the same results as achieved by the embodiments described herein.

For example, the processes depicted in FIGS. 2 and 3 are shown in separate drawings merely to show that each process may be implemented separately and independently, but these process may be integrated into one seamless process. It should also be recognized that the order of many of the steps described with reference to FIGS. 2 and 3 may be varied without adversely affecting the performance of implementations of the present invention. Moreover, one of ordinary skill in the art will recognize that a file may be rendered inaccessible for practical purposes by implementing less than all of the steps enumerated in FIG. 3. Accordingly, there is no intention to limit the invention to the disclosed exemplary forms. Many variations, modifications and alternative constructions fall within the scope and spirit of the disclosed invention as expressed in the claims.

What is claimed is:

1. A method for removing pestware files located on a storage device of a protected computer, the method comprising:
detecting a presence of a pestware file on the storage device while the operating system of the protected computer is limiting access to the pestware file via the operating system;
altering, while the operating system continues to limit access to the file via the operating system, at least a portion of a listing of a plurality of pointers, wherein each of the plurality of pointers in the listing points to a corresponding one of a plurality of locations on the storage device, and the storage device stores each of a plurality of portions of data for the pestware file at a corresponding one of each of the plurality of locations; and
removing, while the operating system continues to limit access to the file via the operating system, the name of the pestware file from a directory entry of the pestware file.

2. The method of claim 1 including:
locating the listing of the plurality of pointers by locating a directory entry for the file.

3. The method of claim 1, wherein the listing of the plurality of pointers is located in a data bitmap, and wherein files on the storage device are organized in accordance with an NTFS system.

4. The method of claim 1, wherein the listing of the plurality of pointers are FAT entries in a FAT table.

5. The method of claim 1, wherein the removing includes removing the name of the pestware file from the directory entry by removing the file entry from a master file table (MFT).

6. The method of claim 1, wherein the removing includes removing the name of the pestware file from a directory entry, wherein files stored on the file storage device are organized in accordance with a FAT system.

7. The method of claim 5, including altering an MFT bitmap so as to indicate to the operating system that an MFT entry for the pestware file is available for reuse.

8. The method of claim 1, including:
deleting at least one of the plurality of portions of data for the pestware file.

9. A system for removing pestware files from a file storage device of a protected computer, the protected computer including an operating system, the system comprising:
a pestware detection module configured to identify a file stored in the file storage device of the protected computer as a pestware file; and
a file removal module configured to:
alter, while the operating system prevents access to the pestware file via the operating system, a listing of a plurality of pointers, wherein each of the plurality of pointers in the listing points to a corresponding one of a plurality of locations on the file storage device, and the file storage device stores each of a plurality of portions of data for the pestware file at a corresponding one of each of the plurality of locations, wherein the altered listing of pointers prevents the operating system from accessing the pestware file.

10. The system of claim 9, wherein the file removal module is configured to remove, while the operating system continues to limit access to the pestware file via the operating system, the name of the pestware file from a directory entry for the pestware file.

11. The system of claim 9, wherein files on the file storage device are organized according to an NTFS organization system and the listing of the plurality of pointers is located in a data bitmap for the file storage device.

12. The system of claim 9, wherein the files on the file storage device are organized according to an FAT organization system and the listing of a plurality of pointers are FAT entries in a FAT table.

13. The system of claim 9, wherein the file removal module is configured to:
delete at least one of the plurality of portions of data for the pestware file.

14. A computer readable medium encoded with instructions for removing pestware files from a storage device of a protected computer, the instructions including instructions for:
detecting a presence of a pestware file on the storage device while the operating system of the protected computer is limiting access to the pestware file via the operating system;
altering, while the operating system continues to limit access to the file via the operating system, a listing of a plurality of pointers, wherein each of the plurality of pointers in the listing points to a corresponding one of a plurality of locations on the storage device, and the storage device stores each of a plurality of portions of data for the pestware file at a corresponding one of each of the plurality of locations; and
removing, while the operating system continues to limit access to the file via the operating system, the name of the pestware file from the directory entry of the pestware file.

15. The computer readable medium of claim 14 including instructions for locating the listing of the plurality of pointers by locating a directory entry for the file.

16. The computer readable medium of claim 14, wherein the listing of the plurality of pointers is located in a data bitmap, and wherein files on the storage device are organized in accordance with an NTFS system.

17. The computer readable medium of claim 14, wherein the listing of the plurality of pointers are FAT entries in a FAT table.

18. The computer readable method of claim 14, wherein the removing includes removing the directory entry for the filename by removing the file entry from a master file table (MFT).

19. The computer readable medium of claim 1, wherein the removing includes removing the name of the pestware file from a directory entry, wherein files stored on the file storage device are organized in accordance with a FAT system.

20. The computer readable medium of claim 14, including instructions for altering the MFT bitmap so as to indicate to the operating system that an MFT entry for the file is available for reuse.

21. The computer readable medium of claim 14 including instructions for deleting at least one of the plurality of portions of data for the file.
